(19) United States
(12) Patent Application Publication
(10) Pub. No.: US 2023/0251918 A1
(43) Pub. Date: Aug. 10, 2023

(54) SYSTEMS AND METHODS FOR FAST AND SCALABLE DATA-INTENSIVE COMPUTATION

(71) Applicant: Hututa Technologies Limited, Hong Kong (HK)

(72) Inventors: Lin Gu, Hong Kong (HK); Zhiqiang Ma, Hong Kong (HK)

(21) Appl. No.: 17/669,332

(22) Filed: Feb. 10, 2022

(51) Int. Cl. G06F 9/54; G06F 9/48; G06F 16/23; G06F 9/455

(52) U.S. Cl. CPC G06F 9/546; G06F 9/4881; G06F 16/2308; G06F 9/45558; G06F 2009/4557

(57) ABSTRACT

The present invention relates to a system (100) and method with a fast distributed data processing engine (105) for fast and scalable data-intensive computation comprising a data model (110) defining an addressable collection of a message space, addressing a message space constellation (115) and the message space with one or more coordinates, updating the message space and the program state with the message following a consistency model, defining an attribute for an area within the message space and running a task in the message space constellation (115). In particular, each task accesses a part of the message space in a subset of the message space constellation (115).

### FIELD OF THE INVENTION

Embodiments of the present invention relate to the field of a Big-Data system framework for processing data and more particularly to a system and a data model for fast and scalable data-intensive computation and method thereof.

### BACKGROUND OF THE INVENTION

“Big data” is typically a very large or complex data system in which traditional data management tools and/or data processing mechanisms (e.g., relational databases and multi-threaded computing in shared memory) are unable to process a collection of data within an acceptable amount of time. Big data can be supported by distributed data substrates that allow the parallel processing capabilities of a plurality of modern multi-process, multi-core servers to be fully utilized.

Data-intensive computing is a class of parallel computing applications in which large volumes of data use a data parallel approach for processing. The data is typically gigabytes, terabytes or even petabytes in size, often referred to as Big Data. The processing of big data naturally shows the pattern of data-intensive computing. Typically, such applications spend most of their processing time on I/O (input/output) and data manipulation, and high-throughput is accomplished by distributing computing tasks to a plurality of compute nodes. One compute node can be a server, a PC, a virtual machine or a general container that can perform computation. The computing tasks process and exchange data among them. A “data model” defines how data is organized, modified and exchanged in such a computing system.

Current data-intensive computing platforms typically use a parallel computing approach combining multiple processors and disks in large commodity computing clusters connected using high-speed communications switches and networks. Many data models organize the data to be partitioned among the available computing resources and processed independently to achieve performance and scalability with data.

A variety of system architectures have been built above distributed file systems for data-intensive computing, including the MapReduce architecture pioneered by Google, now available in an open-source implementation called Hadoop used by Yahoo, Facebook, and many other organizations. MapReduce and Hadoop use distributed files systems to organize data, and the data models rely on the semantics and guarantees of the file systems. But file systems can incur long latencies in data operations, and this affects the performance of the system.

In-memory computation can overcome some issues resulting from the use of distributed file systems by organizing a global namespace carrying a distributed program state in memory. For example, Spark organizes data as distributed operands, and defines a data model called RDD, Resilient Distributed Dataset, to coordinate the data operations. RDD explicitly distributes data as objects on a group of nodes. On the other hand, message passing is a well-known technique in parallel computation as well as general interactions of computing entities. Computing tasks obtain, process and generate data in message queues which can be stored in memory. Typically, messages are relatively small in terms of byte size because queues have difficulty supporting large data, particularly in a distributed system. Moreover, the messages mainly serve for the purpose of information exchange among tasks, and they are managed and used independently of the main application data.

Currently, there are a few works on improving Hadoop and MapReduce with memory-based file systems and data spaces, using memory to store distributed data and storing programmable objects in memory for large-scale computation. There are also inventions for in-memory systems and data models, and Inventions for message processing techniques such as coding and queueing.

US Patent Application No. US10176092B2 titled “System and method for executing data processing tasks using resilient distributed datasets (RDDs) in a storage device” discloses a system and method of providing enhanced data processing and analysis in an infrastructure for distributed computing and large-scale data processing. It uses the Apache Spark framework to divide an application into a large number of small fragments of work, each of which may be performed on one of a large number of compute nodes involving Spark transformations, operations, and actions, which may be used to categorize and analyze large amounts of data in distributed systems. However, the RDD data model mostly follows a “functional” view of data, and it restricts data mutation. In fact, as objects like operands, data in this model can only be recomputed, but not changed. This is a serious constraint on computing and often leads to a large memory footprint.

European Patent Application No. EP3245745B1 titled “System and method for a message passing algorithm” discloses a system and method for a message passing algorithm. In this document, decoder for decodes the Sparse Coded Multiple Access (SOMA) codewords allowing the data streams in a received signal to be distinguished from one another, and ultimately decoded, using an iterative message passing algorithm (MPA). As comparison, our invention focuses on a higher level design of the message-based data model and messaging system, and is oblivious of the underlying message format, including the coding scheme and decoding algorithm.

DOE Patent 8543722 discloses a message passing system using queues and channels. The queues and channels are randomly accessible, and each channel identifies a message unit. As a comparison, traditional message passing systems, such as MPI, mainly manipulate messages in queues and, most of the time, the queues are accessed in a First-In-First-Out (FIFO) manner. But the invention in DOE patent 8543722 does not impose a composite structure for the queues, and there are not notions of the structuring, attributes and consistency model for the queues.

European Patent Application No. EP92302035 discloses a message passing mechanism on a multiprocessor system with a data bus. The messaging controller reads several registers to count the responsive processors, and sends a message when the count is larger than a minimum value. As comparison, our invention designs a way to send a message by posting the message data in a message space, and the sending node does not need to know the identity or count of the destination nodes.

U.S. Pat. No. 10,148,736B1 titled “Executing parallel jobs with message passing on compute clusters” discloses a method and apparatus for executing parallel jobs with message passing on distributed computing systems. Although the method has the ability to store very large data sets, high throughput, reliability and high availability due to features such as data replication, and flexibility. But a large data set employs a message passing interface (MPI) to coordinate the collective execution of the job on multiple compute nodes. And the framework creates a MapReduce cluster and may generate a single key pair for the cluster, which may be downloaded by nodes in the cluster and used to establish secure node-to-node communication channels for MPI messaging.

In spite of its rapid development for half a century, other drawbacks in the currently similar technologies includes slow I/O, faulty distributed operations and expensive parallel programming. Existing systems often rely on data models that favor a set of computations but incur noticeable overhead in the others. As a result, they do not scale well with large datasets, dynamic data flows and mixed reading and mutation operations. Thus, there remains a need to address the shortcomings of the cited prior arts by providing a means to construct an effective software infrastructure to support a wide spectrum of data-intensive workloads.

### SUMMARY OF THE INVENTION

Embodiments of the present disclosure relates to a system with a fast distributed data processing engine for fast and scalable data-intensive computation by implementing a new data model. The system comprises a data model, a message space constellation, and a number of computing tasks. There is often a special scheduler that dispatches and schedules the tasks. This scheduler is called a globalizer because, unlike traditional schedulers, the globalizer neither manages application tasks in program domain nor schedule CPU time in kernel domain. Instead, the globalizer adds a layer between the application task scheduler and the CPU scheduler, and schedules tasks to a distributed set of compute nodes. Moreover, the globalizer is aware of the data model and data spaces when assigning tasks to compute nodes. It is part of the data processing system.

In accordance with an embodiment of the present invention, the data model defines the semantics of a message in a message space with attributes. Moreover, the data model is configured to abstract a program state or data to be messages residing in a constellation of such message spaces. The system materializes program data as messages in message spaces, wherein the message is read, processed and mutated by the task. The message spaces are expressive enough to represent the program state, and, therefore, it is not necessary to add additional mechanisms to store application data in this model. For some purposes such as caching, implementations may choose to add other data storage and processing mechanisms for some part of application data, but it is not necessary or required in this data model. Processed locally or exchanged among nodes, all data are modeled as messages in a constellation of message spaces specially designed for data-intensive computation.

In accordance with an embodiment of the present invention, the message space constellation formalizes the data and their operational semantics. Particularly, the message space constellation includes one or more message spaces. The spaces may intersect, making inter-task communication possible, and they may operate independently from each other, making distributed computing easy to implement. A message space may have one or more areas associated with particular attributes. Typically, an area is defined as a position range within a message space. And, the attributes are persistent (P) attribute, universal (U) or replicated (R) and alike attributes which may be extended and defined by the system. In particular, the “universal” (U) attribute for an area means the space intersects other spaces in the area. This enables the space to communicate with other spaces in the area.

In accordance with an embodiment of the present invention, the message space is numbered from 0 to U-1. Particularly, U has a predefined default value, such as 256. Moreover, a special message space, Space U, comprises all areas with attribute U, and intersects a plurality of spaces of the message space constellation.

In accordance with an embodiment of the present invention, the message space is addressable in the message space constellation and the message is addressable within the message space. For example, a space may be addressed with its space number from 0 to U. A message may be addressed by a combination of the space number and the start and end positions in the message space. Such numbering and combined number sequences are generally defined as coordinates.

In accordance with an embodiment of the present invention, a message space is configured to span one or more compute nodes, and data, in the form of messages, may dynamically migrate from one node to another at run time.

In accordance with an embodiment of the present invention, the message is a sequence of bytes of bounded size and the system permits the message to be stored in fragments potentially on multiple nodes and migrating among nodes.

In accordance with an embodiment of the present invention, the computing task reads and/or accesses and/or posts messages in the message spaces. When sending or posting a message, the message may or may not be delivered to the message space. That is, the message delivery process can be “lossy”.

Another embodiment of the present invention relates to a method for representing and mutating the program state within the message constellation in a distributed computation. The method further comprises steps of defining an addressable collection of message space in a data model, addressing a message space in the constellation and the message in the space with one or more coordinates, updating the message space and the program state with the message operations following a consistency model, defining attributes for an area within the message space, and running a plurality of tasks in the message space constellation. In particular, the addressable collection of the message spaces in the data model is defined to combine the state of the message spaces to form a global program state and regulate mutations of the message spaces and the program state in a message operation. Furthermore, the area within the message space has a combined compatible attribute. And, each of the plurality of tasks in the message space constellation accesses part of the message spaces in a subset of the message space constellation. All tasks in combination maintain and mutate the global program state.

In accordance with an embodiment of the present invention, the method performed by the task comprises steps of abstracting the data to be messaged residing in the message space constellation, materializing the data as messages in message spaces, processing a set of messages from the accessible spaces, generating a new set of messages and posting the new set of messages in the message space, and sending the new set of messages to the message space following a certain consistency model. In particular, the task reads, processes and mutates the messages.

In accordance with an embodiment of the present invention, the method for posting the message in the message space includes steps of locating the message posted in an accessible message space, determining the value of the message, applying changes in the message, and adjusting the contents of multiple message spaces to reflect the newly posted message. If a set of messages are sent, they are either delivered in their entirety or none of the messages are delivered in any space.

Thus, the foregoing objectives of the present invention are attained by employing a system with the data model as described and a method for fast and scalable data-intensive computation and a method thereof.

### BRIEF DESCRIPTION OF THE DRAWINGS

So that the manner in which the above recited features of the present invention is be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating core components of a system for fast and scalable data intensive computation in accordance with an embodiment of the present invention;

FIG. 2 is a pictorial representation illustrating a message space constellation in accordance with an embodiment of the present invention;

FIG. 3 is a flowchart illustrating a method for fast and scalable data-intensive computation in accordance with an embodiment of the present invention;

FIG. 4 is a flowchart illustrating a method for posting messages in the message space in accordance with an embodiment of the present invention;

FIG. 5 is a flowchart illustrating a method performed by the compute task in accordance with an embodiment of the present invention.

### DETAILED DESCRIPTION

The present invention relates to a system (100) with a fast distributed data processing engine (105) for fast and scalable data-intensive computation by implementing a data model (110).

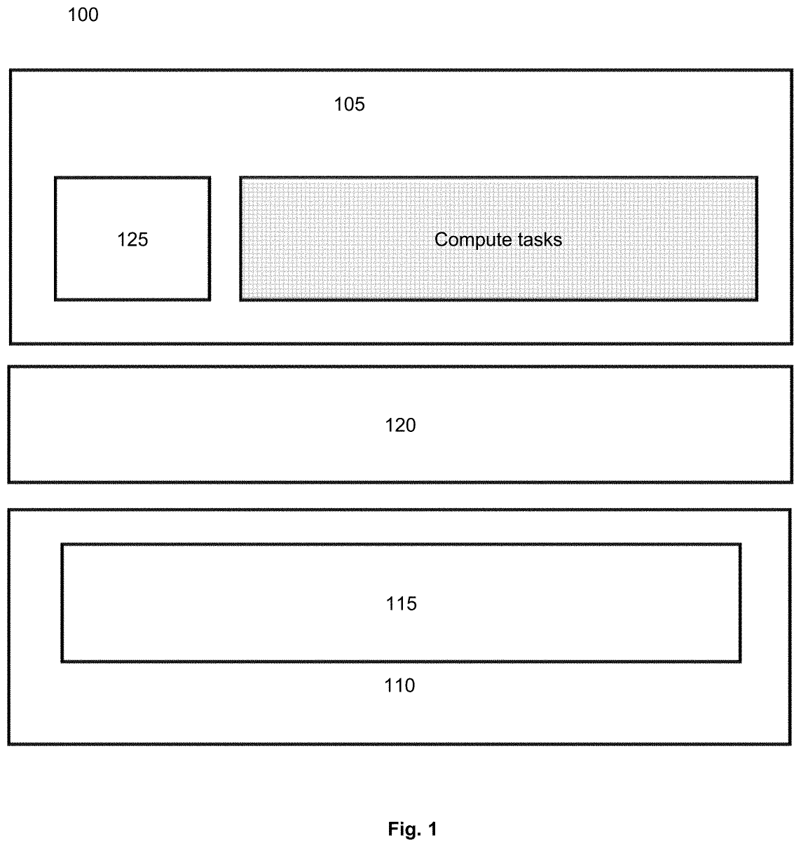

The principles of the present invention and their advantages are best understood by referring to FIGS. 1 to FIGS. 5. In the following detailed description of illustrative or exemplary embodiments of the disclosure, specific embodiments in which the disclosure may be practiced are described in sufficient detail to enable those skilled in the art to practice the disclosed embodiments.

The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

Terms an addressable collection, or constellation are used interchangeably for convenience.

Terms data, data state and program state are used interchangeably for convenience.

FIG. 1 is a block diagram illustrating various components of a system (100) with a fast distributed data processing engine (105) for fast and scalable data intensive computation following a data model (110). In particular, the system (100) is a composite data structure including a data model (110), a message space constellation (115) with one or more spaces, program state/data (120) and a special scheduler called globalizer (125).

In accordance with an embodiment of the present invention, the data model (110) defines the semantics of messages in spaces with horizons to efficiently instantiate change and move large quantities of data in the system (100). Particularly, the data model (110) is a unified global data space constellation composed of a set of data spaces with well-defined message-oriented operational semantics. Moreover, the data model (110) defines an addressable collection, or constellation of addressable message spaces, combines the state of the message spaces to form the global program state and mutates the message space and program state in message-based operations. Further, the data model (110) abstracts data to be messaged residing in a message space constellation (115). And, the data is materialized as messages in message spaces. The messages may be read, processed and mutated by tasks in the message spaces. After processing a set of messages, the task may generate a new set of messages, and post them in the message space. The processing logic materializes in the system (100) as the task runs in the message space.

A software construct called container is constructed in the system (100) to facilitate the execution of a compute task. Each container provides system services to the task. In particular, the container packages a certain amount of computing resources, such as CPU cores and RAM capacity and provides system services related to the data. Moreover, the container facilitates access to the message spaces. In an implementation, it is often convenient to let the container also monitor fault events, control heartbeats, and handle communication details.

In accordance with an embodiment of the present invention, the task accesses messages in its space and Space U (intersecting space with other spaces). As long as the resources on all nodes can materialize the message space constellation, the total quantity of processed data by one task may exceed the memory and secondary storage capacity of the container and the node on which this task runs. Particularly, the container facilitates such accesses through inter-container communication. A container runs on a compute node.

In accordance with an embodiment of the present invention, a message space may instantiate on zero, one or more containers or nodes. If a space is not instantiated on any container, no compute task can access the messages in that space. Otherwise, the task may access messages partially materialized in local or remote containers or nodes, and perform transfer for messages or message fragments. Particularly, the globalizer determines or speculates the messages a task accesses, and allocates the task to execute in a container that instantiates the message spaces. Ideally, the tasks are scheduled to containers that have most of the messages (data) needed by the tasks. And, if all containers with good locality for the task are busy and the task has to be scheduled to a container that does not have the messages (data), the messages (data) will be dynamically migrated to the container and the data in the newly posted message by the task will be likely stored in or near to that container. Thus, the data processing engine changes the data distribution in the system (100) dynamically according to the tasks and container distribution. Further, the scheduler communicates and coordinates with the message registry on the active locations of messages.

To quickly locate messages, there may be message registries that manage messages or message blocks in the message space constellation (115). Particularly, the message registry is maintained on one or more designated compute nodes, and changes to the registry are recorded and coordinated by the registry. The registry conducts coordination for the state change, i.e., message posting of the system (100). For example, the registry keeps track of the state of message posting. Subsequently, the changes of the messages on appropriate horizons are handled by containers and inter-container communication.

In accordance with an embodiment of the present invention, containers help to transfer accessed message data from remote nodes to the local message space if the data are not present locally. Particularly, for posting messages the container coordinates with the message registry to update the message space state and conducts data transfer from local nodes to other nodes for overflow handling, locality control or replication. Although pre-fetching is performed, the behavior is still dominated by on-demand transfer. The transfer method is effective for random accesses in computation as the system (100) avoids a large amount of communication when there is no real access to certain parts of a message.

In accordance with an embodiment of the present invention, the data model (110) enforces data consistency by imposing new constraints to the task. In constraint 1, the task resides in one message space besides Space U limiting the data and the task may access to the capacity of a space (16 TB by default). In constraint 2, the task observes one horizon. And in constraint 3 the task's lifespan terminates after it sends all messages. The constraints 2 and 3 combine to limit the task to conduct processing on one horizon and create at most one new horizon in an event-driven programming style. Particularly, the task is not supposed to conduct multiple send-receive round-trip communication cycles to interact with other tasks in its lifespan.

In accordance with another embodiment of the present invention, the system (100) includes I/O channels through which the task can interact with another task or external programs in multiple send-receive cycles. But messages in such communication are considered “out-of-horizon”—they do not belong to any horizons.

In accordance with an embodiment of the present invention, the globalizer (125) is configured to schedule the task to run in a container on a compute node. And, multiple programming language interfaces connect the system (100) service to the applications. The data model (110) is not programming language specific, and may support multiple programming languages. To support a new language, library functions for the new language are written to access the message spaces. The data model (110) requires one task resides in one space and implements the task functions by creating a stub task in the same space as the user task and maps messages to a chunk of memory maintained by the library.

In accordance with an embodiment of the present invention, the message space constellation (115) is configured to formalize data of different properties. Particularly, the message space constellation (115) includes one or more message spaces with one or more areas wherein each area is associated with a set of attributes defined within a position range. In accordance with an embodiment, the message spaces in the data model (110) are numbered from 0 to U−1. The value of U is configurable with a default value of 256. The special space, Space U, intersects all other spaces. Hence, total spaces in the message space constellation (115) is U+1 space.

In accordance with an embodiment of the present invention, program state or data (120) are in message spaces, and a message space may be instantiated on multiple compute nodes. Therefore, the program state or data (120) may be services by a plurality of nodes, and can migrate from one node to another at runtime.

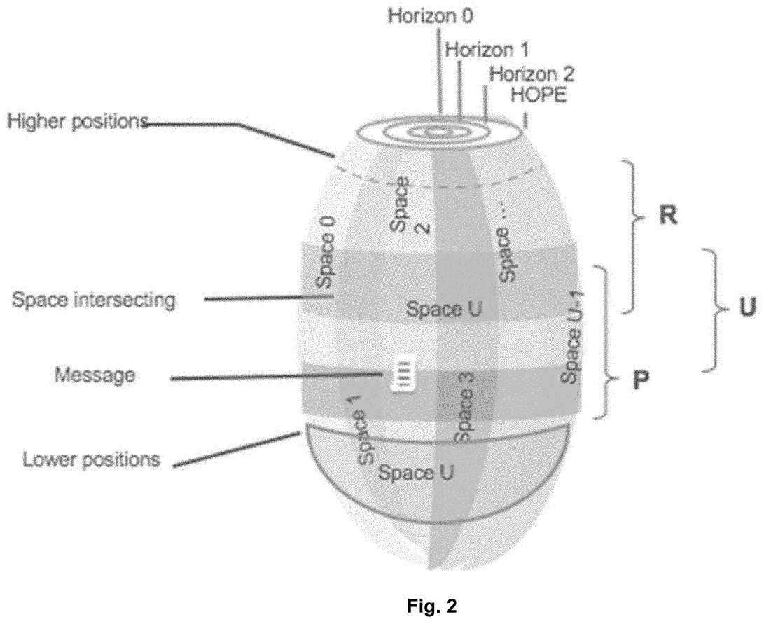

FIG. 2 is a pictorial representation illustrating a message space constellation (115) in accordance with an embodiment of the present invention. Particularly, the parameters and attributes are illustrative and can be changed in implementations.

Although it is not required, it is convenient for a message space to have a fixed capacity, S, in bytes.

In accordance with an embodiment of the present invention, without loss of generality, a message is a sequence of bytes of a bounded size, although other forms of message organizations and definitions of coordinates are possible. Particularly, the message is posted in a space at a byte position given that the space is able to contain the entire byte sequence of the message.

In an exemplary case, when a message of size M is posted at the position P in Space X. Then the message resides in positions P to P+M−1 in the space, with the first byte of the message residing at position P and all the remaining bytes following the sequence order

In accordance with an embodiment of the present invention, all spaces in the message space constellation (115) may have the same capacity, and a space may address positions with byte offsets from 0 to 2⁴⁴-1. Thus, a compute task may address a message with an identifying vector, such as a number pair <message space number, byte offset>. If necessary, an element for the terminating position can be added to the vector. We call such an identifying vector a coordinate.

When multiple spaces intersect, a communication pattern with delays among tasks is made possible. Space U in the message space constellation (115) facilitates such inter-task communication. The Space U starts and ends at configurable positions and intersects other spaces in the position range. Because of the consistency enforcement, such full cycle of such communication does not complete until the lifespan of one task is terminated. This creates a delay in the communication, but ensures consistency of the message operation semantics among a plurality of compute tasks.

In accordance with an embodiment, for a message-based abstraction, the behavior of data read and write among multiple tasks is defined with natural message posting and reception semantics in the message space. In particular, the data model (110) defines data in terms of messages. A task can post a message. If the posting operation is successful, a new horizon is created and the content of the message on the new horizon is what the task has just posted. A message can be received and read after it is posted. The content of the message is the instantiated on the current horizon when the message is received. Note the “current horizon” for the receiving task may be different from the “new horizon” for the posting task because there can be intermediate horizons in between, and the message content may have changed several times between the posting and receiving operations. Each task reads the content of the message as received from the message space, and mutate its content. Moreover, multiple tasks can read and mutate the content of a message simultaneously. The mutations in that message do not affect the observations of other tasks who have received the same message in the same space.

In accordance with another embodiment, different tasks may read different messages at the same position of a space. Particularly, the horizons materialize the presence of messages in the spaces. And, every space materializes on a number of horizons, and a horizon may be built on part of a space, one space or multiple spaces, depending on implementation. The same message in the space on different horizons may be different.

The currently visible parts of all horizons are called the Horizon Of Present Existence (HOPE). Roughly speaking, HOPE is the current “presentation” of all the message spaces. The content of messages are observed on HOPE and it may combine contents from multiple horizons. The “visible” part of a horizon is the coordinates on that horizon for which no newer horizon defines a new instantiation. In the simplified case that the system always instantiates a horizon on an entire space, HOPE is the combination of all most recent horizons for all message spaces.

In accordance with an embodiment of the present invention, the area in a message space is associated with certain attributes. In particular, possible attributes include but are not limited to persistent (P), universal (U) and replicated (R) as depicted in FIG. 2. Alternatively, new attributes may be added.

The attribute P indicates that the region is persistent. And, the messages posted in this P region are automatically written to hard disks.

The attribute R indicates that the region is replicated, and the system (100) makes replicated copies of the message contents in that area, often on different nodes, to enhance reliability.

An area with both P and R attributes naturally provides a storage function equivalent to the 3-way replicated underlying storage of GFS and HDFS. In particular, in the data model (110), the system state changes when a task's lifespan terminates, the messages are posted and, potentially, the horizon is moved to the next level. The system (100) conducts replication as an innate step of the task termination process. If the replication fails, then message posting fails and the messages are dropped.

The attribute U indicates that the area is in Space U (the crosscutting space that intersects other spaces). A message posted in Space U is mirrored to all sibling areas in Space 0, Space 1, . . . Space U−1. The operations are coordinated in multiple spaces through the pivotal area of Space U and the messages posted in Space U are universally atomic. For example, if a set of messages are posted in Space U successfully, all of them are delivered to all spaces.

The areas with an attribute are defined with the position ranges in a space, such as [10, 19], [2⁴¹, 2⁴², [4 TB, 6 TB]. The boundaries of the ranges have effect on all applicable message spaces. For example, when a range [10, 19] has an attribute, then the area in the range [10, 19] in Space U has that attribute, too, if the range [10, 19] is in Space U.

An exemplary setting of the ranges with P, U and R attributes is illustrated in FIG. 2. Although the layout has only one range for one attribute, the definition allows an attribute to be defined for multiple ranges. Alternatively, one position in a space may be covered by multiple ranges, then the space may have multiple attributes.

In accordance with an embodiment of the present invention, when posting a message, the message is either delivered or lost. When a message is delivered, the data model (110) requires the message to satisfy certain criteria defined by the implementation. For example, the criterion can be the message being delivered in its entirety or the message passing a checksum verification. Moreover, if the task posts multiple messages, the system may require the messages in one space are either all delivered, or all dropped.

In accordance with an embodiment, the task exists on HOPE and observes the content of messages in a space on one or more horizons constituent to HOPE. Thus, when a task posts a message, the message is visible to other tasks only when no other message changes HOPE in a way that blocks the view of the message. If the message posting is successful, the message materializes on a new HOPE. When other tasks in the previous HOPE can still post messages, and the messages materialize on new HOPE as long as the messages are not blocking each other. An implementation may use reasonable rules to decide whether two messages block each other. For example, two message that do not share coordinates may be considered non-blocking, or two messages far enough from each other may be considered non-blocking.

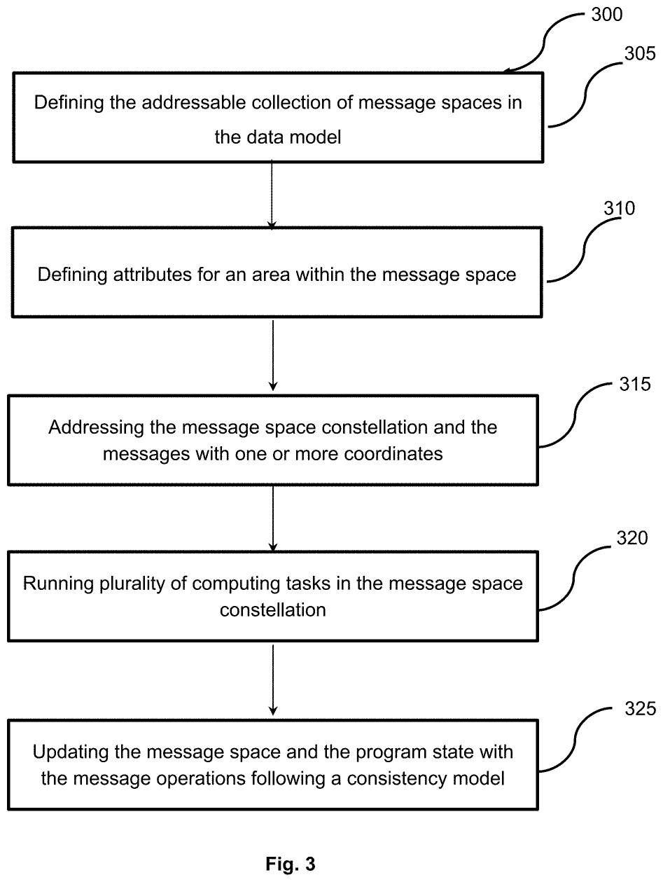

FIG. 3 is a flowchart illustrating a method for fast and scalable data-intensive computation representing and mutating the program state of a distributed computation. Method 300 starts at 305 and proceeds to steps 310 and 315.

At step 305, an addressable collection of a message space is defined in a data model (110) to combine the state of the message space to form a global program state. In particular, the addressable collection of the message space also regulates mutations of the message space and the program state in a message operation.

Step 305 proceeds to step 310. At step 310, an attribute is defined for the area within the message space. An individual attribute is defined for an area, while the area and intersecting spaces have a combined group of compatible attributes. Step 310 proceeds to step 315. At step 315, the message space constellation (115) and the messages are addressed with one or more coordinates.

Step 315 proceeds to step 320. At step 320, a plurality of computing tasks run in the message space constellation (115). In particular, each task accesses a part of the message space in a subset of the message space constellation (115).

Step 320 proceeds to step 325. At step 325, the message space and the program state are updated with the message operations following a consistency model.

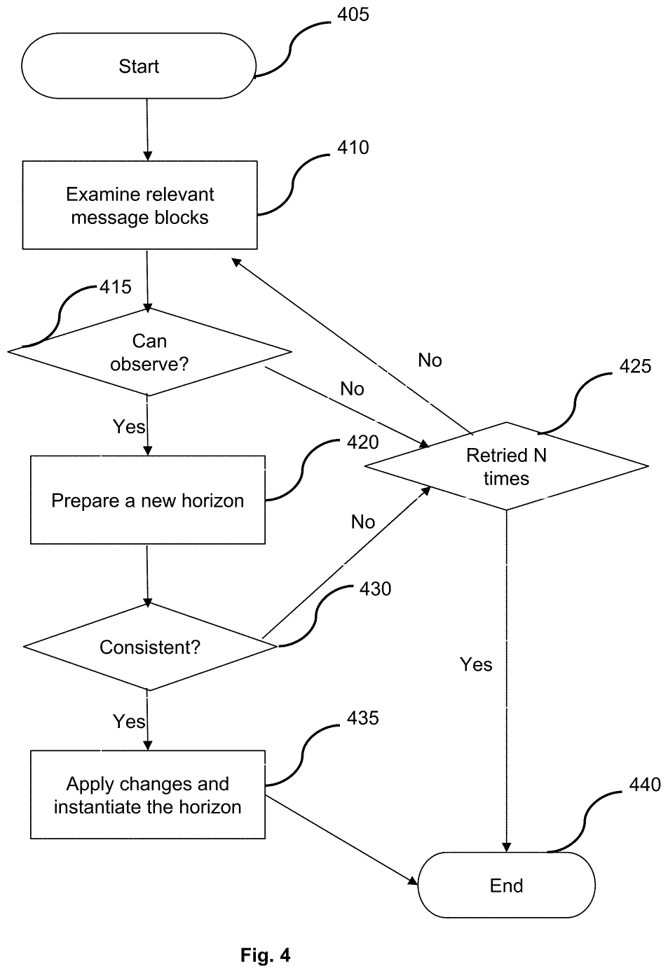

FIG. 4 is a flowchart illustrating a method for posting messages in the message space in accordance with an embodiment of the present invention. Method starts 405 and proceeds to step 410, 415,420,425,430,435.

At step 405 the method starts. At step 410, the messages posted in related message blocks are examined.

At step 415, a determination is made whether the message in the message set can be observed, i.e., not blocked.

In one embodiment, when the determination is “YES” and the message in the message set is observed, then the method proceeds to step 420.

In another embodiment, when the determination is “NO” and the message in the message set is not observed, then the method proceeds to step 425.

At step 420, a new horizon is prepared. Step 420 proceeds to step 430.

At step 425, if the message in a message set is not observed due to but is not limited to blocked view to HOPE, multiple retries are made for the observation. Then the system (100) retries and nullifies the posting of the entire message set. If after retrying N times also the message is not observed then the posting of the entire message set is nullified. Step 425 proceeds to step 440.

At step 430, another determination is made whether the new horizon is consistent.

In one embodiment, when the determination is “YES” and the horizon is consistent, then the method proceeds to step 435.

At step 435, changes are applied to the messages posted in the related message blocks and the new horizon is instantiated.

In another embodiment, when the determination is “NO” and the horizon is not consistent, then the method proceeds to step 425.

Steps 425 and 435 proceed to step 440. At step 440, the process is terminated.

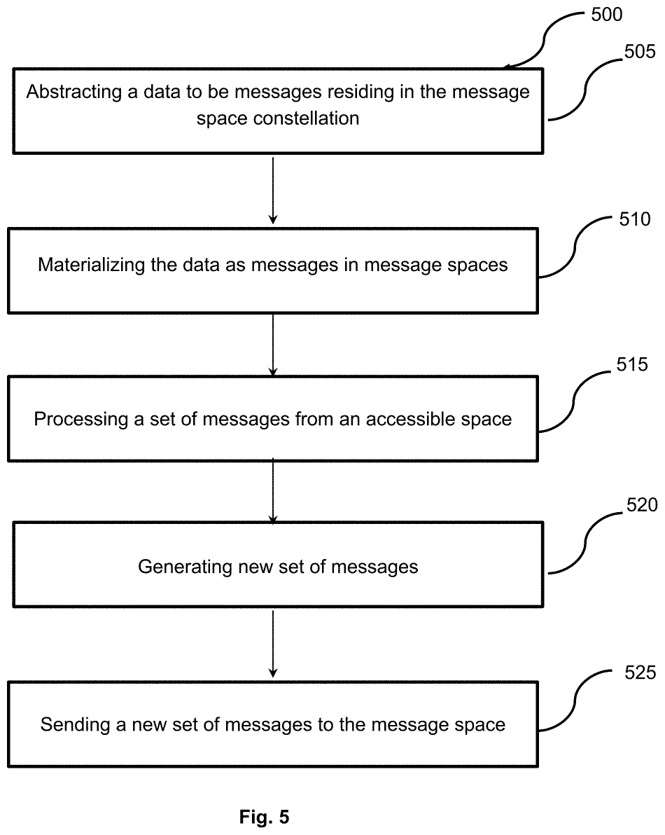

FIG. 5 is a flowchart illustrating a method performed by the task in accordance with an embodiment of the present invention. The method 500 starts at step 505 and proceeds to step 510, 515, 520 and 525.

At step 505, data to be messages residing in the message space constellation (115) is abstracted.

At 510, the data as messages in message spaces is materialized. In particular, the message is read, processed and mutated by the task.

At 515, a set of messages from an accessible space is processed.

At 520, a new set of messages are generated and posted in the message space.

At step 525, a new set of messages is sent to the message space and posted following a certain consistency model.

The present invention provides advantages including higher scalability, enhanced efficiency, efficient scheduling, Efficiency of memory usage, data and tasks scheduling, persistency, high performance, wide spectrum data intensive workload support, low-latency operations. The system (100) scales almost linearly to a very large installation size avoiding the complication of synchronization control among a large number of loosely-coupled compute nodes. Moreover, dynamic data migration improves locality and enables Data model (110) to optimize the internal data and work flows to enhance the performance of the computation.

The invention permits efficient implementation on commodity computing hardware in various platforms such as but not limited to Intel 64 platforms and in various languages and systems such as but not limited to a local Linux system to manage local resources on a compute node.

In view of the foregoing, it will now be appreciated that the elements of the block diagram and flowcharts support combinations of means for carrying out the specified functions and processes, combinations of steps for performing the specified functions and processes, program instruction means for performing the specified functions and processes, and so on.

It will be appreciated that computer program instructions may include computer executable code. A variety of languages for expressing program instructions are possible, including without limitation C, C++, Java, JavaScript, assembly language, Perl, and so on. Such languages may include assembly languages, hardware description languages, database programming languages, functional programming languages, imperative programming languages, and so on.

The functions, systems and method herein described could be utilized and presented in a multitude of languages. Individual systems may be presented in one or more languages and the language may be changed with ease at any point in the process or method described above. One of ordinary skill in the art would appreciate that there are numerous languages the system could be provided in, and embodiments of the present disclosure are contemplated for use with any language.

The invention is capable of myriad modifications in various obvious aspects, all without departing from the spirit and scope of the present disclosure. Accordingly, the drawings and descriptions are to be regarded as illustrative in nature and not restrictive.

The features described herein may be combined to form additional embodiments and sub-elements of certain embodiments may form yet further embodiments. The foregoing summary of the present disclosure with the preferred embodiment should not be construed to limit the scope of the invention. It should be understood and obvious to one skilled in the art that the embodiments of the invention thus described may be further modified without departing from the spirit and scope of the invention.

What is claimed is:

1. A system with a fast distributed data processing engine for fast and scalable data-intensive computation comprising:
a data model to define an addressable collection, or a constellation of addressable “message spaces”, combine state of the message spaces to form a global program state, and regulate mutations of message-based operations in a message space and a program state;
attributes to be defined within areas or position ranges in a space wherein some attributes make spaces to intersect to share data and exchange information;
the program state or a data space materialized as messages in the message spaces with messages and data, dynamically migrating from one node to another at a run time; and
a plurality of tasks running in the message space constellation and, with each task accessing a subset of the message space constellation and all tasks combined together maintaining and mutating the program state of the computation.

2. The system as claimed in claim 1, wherein the message spaces contain areas with different attributes defined by a designer as applicable, and typical attributes include a persistent (P) attribute, a universal (U) attribute and a replicated (R) attribute.

3. The system according to claim 1, wherein the message spaces are addressable in the message space constellation, and the messages are addressable within the message spaces.

4. The system as claimed in claim 2, wherein an area in the message spaces may have the universal (U) attribute configured to facilitate communication among spaces by crosscutting the area into a plurality of spaces of the message space constellation, or intersecting the message spaces in the area.

5. The system as claimed in claim 1, wherein the data model is configured to abstract a program state or data residing in the message space constellation and materializes the data as the message in the message space.

6. The system as claimed in claim 1, wherein the message space is addressable in the message space constellation and the message is addressable within the message space.

7. The system as claimed in claim 1, wherein the message is a sequence of bytes of a bounded size.

8. The system as claimed in claim 1, wherein the data spaces are logical constructs, and messages or parts of a message (message fragments) are potentially distributed among multiple nodes.

9. The system as claimed in claim 1, wherein the program state or data are able to dynamically migrate from one node to another at a run time as the messages and message fragments distribute and re-distribute among nodes.

10. The system as claimed in claim 1, wherein when a computing task is created, the task materializes accessible data as visible parts of messages in the message spaces and reads and/or accesses and/or posts and/or processes and/or mutates the message in the message space.

11. The system as claimed in claim 1, wherein the system further includes a globalizer configured to schedule the task to run on a compute node, which can be a container, a VM, a server, or any other types of compute node.

12. A method for fast and scalable data-intensive computation representing and mutating a program state of a distributed computation, comprising steps of:
defining an addressable collection of a message space in a data model to combine state of a message space to form a global program state and regulate mutations of the message space and the program state in a message;
defining an area in the message spaces to have certain attributes including a persistent (P) attribute, a universal (U) attribute and a replicated (R) attribute;
addressing a message space constellation and the message space with one or more coordinates;
running a task in the message space constellation, wherein each task accesses a subset of the message space constellation; and
updating the message space and the program state with the message following a consistency model;
wherein the task materializes accessible data as visible parts of messages in the message space and reads and/or accesses and/or posts and/or processes and/or mutates the message in the message space.

13. The method according to claim 12, wherein the method performed by the task comprising steps of:
abstracting a data to be messages residing in the message space constellation;
materializing the data as messages in message spaces, wherein the message is read, processed and mutated by the task;
processing a set of messages from an accessible space, generating a new set of messages after processing a set of messages from the accessible space and posting the new set of messages in the message space; and
sending a new set of messages to the message space following a certain consistency model;
wherein the consistency model enforces a level of predictable behavior for concurrent reads and writes of messages.

14. The method according to claim 12, wherein, the method for posting the message in the message space includes steps of:
examining the message posted in a related message set;
determining whether the message posted in a related message set is observed;
preparing a new horizon;
determining whether the new horizon is consistent; and
applying changes in message and instantiating the horizon.

15. The method according to claim 12, wherein message is a sequence of bytes of a bounded size.

16. The method according to claim 12, wherein the method further includes a step of scheduling the task by a globalizer.

17. The method as claimed in claim 12, wherein an area in the message space contains a universal (U) attribute for facilitating communication among spaces by crosscutting the- area into a plurality of spaces of the message space constellation, or intersecting the message spaces in the area.
